(19) United States
(12) Patent Application Publication
(10) Pub. No.: US 2025/0130880 A1
(43) Pub. Date: Apr. 24, 2025

(54) SYSTEMS AND METHODS FOR DETERMINING A LIST OF CONFIGURABLE ITEMS FOR INCIDENT CORRELATION

(71) Applicant: Fidelity Information Services, LLC, Jacksonville, FL (US)

(72) Inventors: John C. PLATAIS, Menomonee Falls, WI (US); Ranadhir GHOSH, St Johns, FL (US)

(21) Appl. No.: 18/492,167

(22) Filed: Oct. 23, 2023

(51) Int. Cl. G06F 11/07; G06F 16/248

(52) U.S. Cl. CPC G06F 11/0781; G06F 16/248

(57) ABSTRACT

A method for determining configurable items related to an incident is disclosed. The method includes receiving a data object indicating an occurrence of a current incident, the data object including metadata; determining, utilizing a first model and based on the metadata, one or more first configurable items associated with one or more applications and/or services related to the current incident; determining, utilizing a second model and based on the metadata, one or more second configurable items associated with one or more products related to the current incident; determining, utilizing a third model and based on the metadata, one or more third configurable items associated with one or more lines of business and/or logical associations related to the current incident; generating a list of configurable items by aggregating the one or more first configurable items, the one or more second configurable items, and the one or more third configurable items.

### TECHNICAL FIELD

The present disclosure relates generally to the field of information technology (IT) management systems, and, more particularly, to systems and methods for determining a list of configurable items for incident correlation.

### BACKGROUND

Changes made to an IT system creates some degree of risk that the system will not continue to perform as expected. Additionally, even if system performance is not immediately affected, a change to a system may cause issues later, and a significant amount of time and resources may need to be expended to determine what caused the change in performance of the system.

For example, in software, deploying, refactoring, or releasing software code has different kinds of associated risk depending on what code is being changed. Not having a clear view of how vulnerable or risky a certain code deployment may be increases the risk of system outages. Code deployment poses risks for a company, and platform modernization is a continuous process. A technology shift is a big event for any product, and entails a large risk as well as an opportunity for a software company.

Outages and/or incidents cost companies resources in service-level agreement payouts and other obligations, but more importantly, wastes time for personnel via rework, and may risk adversely affecting a company's reputation with its customers. Highest costs are attributed to bugs reaching production, including a ripple effect and a direct cost on all downstream teams. Also, after a modification has been deployed, an incident team may waste time determining what caused a change in the performance of a system.

Modern IT architectures have become increasingly complex. Understanding and resolving alerts from a large system across the IT landscape frequently involves decentralized personnel and systems as well as individual ticket and time-separated resolutions, resulting in significant inefficiencies in large IT organizations. When an incident occurs in a particular configurable item, the underlying problem may be related to a connected or separate configurable item. It may be difficult and time-consuming for individuals to research related configurable items when an incident occurs.

The present disclosure is directed to addressing this and other drawbacks to the existing computing system incident analysis techniques.

The background description provided herein is for the purpose of generally presenting context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

In some aspects, the techniques describe herein related to computer implemented method for determining a list of configurable items related to an incident, the method including: receiving a data object indicating an occurrence of a current incident, the data object including metadata; determining, utilizing a first model and based on the metadata, one or more first configurable items associated with one or more applications and/or services related to the current incident; determining, utilizing a second model and based on the metadata, one or more second configurable items associated with one or more products related to the current incident; determining, utilizing a third model and based on the metadata, one or more third configurable items associated with one or more lines of business and/or logical associations related to the current incident; generating a list of configurable items by aggregating the one or more first configurable items, the one or more second configurable items, and the one or more third configurable items; and outputting the list of configurable items.

In some aspects, the techniques described herein relate to a method, further including: filtering the list of configurable items to remove any redundant configurable item.

In some aspects, the techniques described herein relate to a method, wherein determining the one or more third configurable items includes confirming that the one or more lines of business are stored in association with the current incident.

In some aspects, the techniques described herein relate to a method, wherein determining the one or more third configurable items further includes searching logical levels for the one or more lines of business to determine one or more businesses and/or applications related to the one or more lines of business.

In some aspects, the techniques described herein relate to a method, wherein determining the one or more third configurable items further includes extracting one or more configurable items associated with the one or more businesses and/or applications.

In some aspects, the techniques described herein relate to a method, wherein determining the one or more third configurable items further includes: applying an association model to the extracted one or more configurable items associated with the one or more businesses and/or applications to determine the one or more third configurable items, wherein the association model is configured to determine configurable items that have been affected by past incidents that also affected the current incident.

In some aspects, the techniques described herein relate to a method, wherein determining the one or more first configurable items includes analyzing historical incident data utilizing an association model to determine configurable items that were affected during one or more past incidents related to the one or more applications and/or services.

In some aspects, the techniques described herein relate to a method, wherein the historical incident data includes data that is input by a user to indicate applications and/or services related to past incidents.

In some aspects, the techniques described herein relate to a method, wherein determining the one or more second configurable items includes analyzing historical incident data utilizing an association model to determine configurable items that were affected during one or more past incidents related to the one or more products.

In some aspects, the techniques described herein relate to a method, wherein the historical incident data includes data that is input by a user to indicate products related to past incidents.

In some aspects, the techniques described herein relate to a method, wherein the data object is representative of a configurable item.

In some aspects, the techniques described herein relate to a method, wherein the metadata includes: historical incident data for the data object; and a line of business for the data object, the line of business including an association logic linking the line of business with one or more of: a business service, a service offering, an application, an application instance or web service, a server, or a service.

In some aspects, the techniques described herein relate to a system, the system including a memory having processor-readable instructions stored therein; and at least one processor configured to access the memory and execute the processor-readable instructions to perform operations including: receiving a data object indicating an occurrence of a current incident, the data object including metadata; determining, utilizing a first model and based on the metadata, one or more first configurable items associated with one or more applications and/or services related to the current incident; determining, utilizing a second model and based on the metadata, one or more second configurable items associated with one or more products related to the current incident; determining, utilizing a third model and based on the metadata, one or more third configurable items associated with one or more lines of business and/or logical associations related to the current incident; generating a list of configurable items by aggregating the one or more first configurable items, the one or more second configurable items, and the one or more third configurable items; and outputting the list of configurable items.

In some aspects, the techniques described herein relate to a system, the operations further including filtering the list of configurable items to remove any redundant configurable item.

In some aspects, the techniques described herein relate to a system, wherein determining the one or more third configurable items includes confirming that the one or more lines of business are stored in association with the current incident.

In some aspects, the techniques described herein relate to a system, wherein determining the one or more third configurable items further includes: searching logical levels for the one or more lines of business to determine one or more businesses and/or applications related to the one or more lines of business.

In some aspects, the techniques described herein relate to a system, wherein determining the one or more third configurable items further includes: extracting one or more configurable items associated with the one or more businesses and/or applications.

In some aspects, the techniques described herein relate to a system, wherein determining the one or more third configurable items further includes applying an association model to the extracted one or more configurable items associated with the one or more businesses and/or applications to determine the one or more third configurable items, wherein the association model is configured to determine configurable items that have been affected by past incidents that also affected the current incident.

In some aspects, the techniques described herein relate to a system, wherein determining the one or more first configurable items includes analyzing historical incident data utilizing an association model to determine configurable items that were affected during one or more past incidents related to the one or more applications and/or services.

In some aspects, the techniques described herein relate to a non-transitory computer readable medium storing processor-readable instructions which, when executed by at least one processor, cause the at least one processor to perform operations including: receiving a data object indicating an occurrence of a current incident, the data object including metadata; determining, utilizing a first model and based on the metadata, one or more first configurable items associated with one or more applications and/or services related to the current incident; determining, utilizing a second model and based on the metadata, one or more second configurable items associated with one or more products related to the current incident; determining, utilizing a third model and based on the metadata, one or more third configurable items associated with one or more lines of business and/or logical associations related to the current incident; generating a list of configurable items by aggregating the one or more first configurable items, the one or more second configurable items, and the one or more third configurable items; and outputting the list of configurable items.

Additional objects and advantages of the disclosed embodiments will be set forth in part in the description that follows, and in part will be apparent from the description, or may be learned by practice of the disclosed embodiments. The objects and advantages of the disclosed embodiments will be realized and attained by means of the elements and combinations particularly pointed out in the appended claims.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate several embodiments and together with the description, serve to explain the principles of the disclosure.

FIG. 1 depicts an exemplary system overview for a data pipeline for an artificial intelligence model to predict and troubleshoot incidents in a system, according to one or more embodiments.

FIG. 2 depicts an exemplary block diagram of a system for determining a list of related configurable items to an incident, according to one or more embodiments.

FIG. 3 depicts an exemplary flowchart for determining a list of related configurable items to an incident, according to one or more embodiments.

FIG. 4 depicts an exemplary chart of the line of business associated with an exemplary configurable item, according to one or more embodiments.

FIG. 5 depicts a flowchart for determining a list of related configurable items to an incident, according to one or more embodiments.

FIG. 6 illustrates a computer system for executing the techniques described herein, according to one or more embodiments of the present disclosure.

### DETAILED DESCRIPTION OF EMBODIMENTS

The present disclosure relates generally to the field of software testing, and, more particularly, to systems and methods for finding historically similar incidents.

The subject matter of the present disclosure will now be described more fully with reference to the accompanying drawings that show, by way of illustration, specific exemplary embodiments. An embodiment or implementation described herein as “exemplary” is not to be construed as preferred or advantageous, for example, over other embodiments or implementations; rather, it is intended to reflect or indicate that the embodiment(s) is/are “example” embodiment(s). Subject matter may be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of exemplary embodiments in whole or in part.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section.

The present disclosure relates generally to the field of information technology (IT) management systems, and, more particularly, to systems and methods for determining a list of configurable items for incident correlation.

Software companies have been struggling to avoid outages from incidents that may be caused by upgrading software or hardware components, or changing a member of a team, for example. An incident may be an occurrence that can disrupt or cause a loss of operation, services, or functions of a system.

For example, an information technology (IT) management system may receive incidents at invariable rates throughout the day. When incidents are received, an incident may relate to a particular configurable item (CI). A configurable item may refer a component of a system that can be identified as a self-contained unit for purposes of change control and identification. For example, a particular application, service, particular product, server, may be defined by a configurable item. When an incident occurs for a particular configurable item, the root cause of the incident may not be visible by analyzing the particular configurable item. In order to determine a root cause of an incident, it may be valuable to identify a list of related configurable items in order to determine a root cause of the incident. A challenge may be that databases storing configurable items and relationships therebetween may be either not created, not updated, or missing data.

For example, a system may include a configuration management database (CMDB) for configurable items (CIs) (collectively CMDB_CI). The CMDB_CI may be a part of an IT service management system that is used to track individual configure items. The CMDB_CI may store information about a configurable item's attributes, dependencies, and change to its configuration over time. The CMDB_CI may also link particular configurable items as related. Unfortunately, the CBDB_CIs for a system may be not updated or missing data, so it may be difficult to identify related configurable items to a particular configurable item from the CMDB_CI.

To address the above-noted problem the present disclosure describes systems and methods to determine a list of configurable items for incident correlation. The identified list of configurable items may show correlated events based on the incident detected for the particular configurable items.

One or more embodiments described herein may utilize machine learning techniques to combine database definitions and empirical data to determine lists of related CIs. For example, the empirical data may be most useful for determining a full list of related CIs. The empirical data may for example refer to historical incident data that has been received by a system. The empirical data may, for each major incident, include inputted information (e.g., externally inputted information) regarding related applications and services, as well as related products that are affected when a past incident occurred.

One or more embodiments may include a multi-faceted approach to review empirical datasets to determine the lists of related CIs. For example, three distinct modules may review the empirical data to create separate lists. For example, a first module may review impacted applications and/or services related to an incident. A second module may review affected products related to an incident. A third module may review lines of business for the incident system. The outputted list of related configurable items may assist with determining the root cause of the incident.

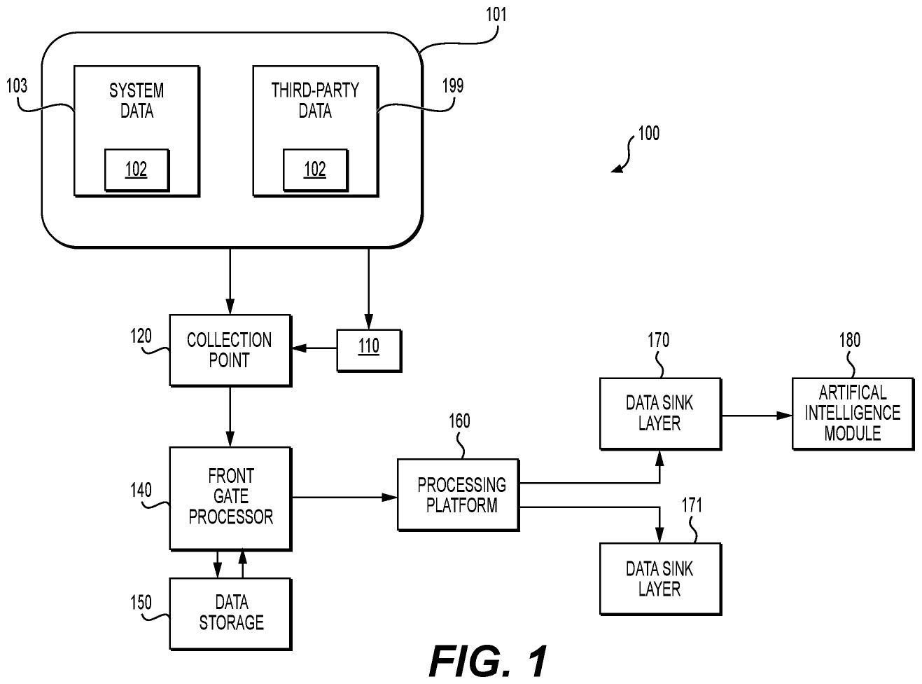

FIG. 1 depicts an exemplary system overview for a data pipeline for an artificial intelligence model to predict and troubleshoot incidents in a system, according to one or more embodiments. The data pipeline system 100 may be a platform with multiple interconnected components. The data pipeline system 100 may include one or more servers, intelligent networking devices, computing devices, components, and corresponding software for aggregating and processing data.

As shown in FIG. 1, a data pipeline system 100 may include a data source 101, a collection point 120, a secondary collection point 110, a front gate processor 140, data storage 150, a processing platform 160, a data sink layer 170, a data sink layer 171, and an artificial intelligence module 180.

The data source 101 may include in-house data 103 and third party data 199. The in-house data 103 may be a data source directly linked to the data pipeline system 100. Third party data 199 may be a data source connected to the data pipeline system 100 externally as will be described in greater detail below.

Both the in-house data 103 and third party data 199 of the data source 101 may include incident data 102. Incident data 102 may include incident reports with information for each incident provided with one or more of an incident number, closed date/time, category, close code, close note, long description, short description, root cause, or assignment group. Incident data 102 may include incident reports with information for each incident provided with one or more of an issue key, description, summary, label, issue type, fix version, environment, author, or comments. Incident data 102 may include incident reports with information for each incident provided with one or more of a file name, script name, script type, script description, display identifier, message, committer type, committer link, properties, file changes, or branch information. Incident data 102 may include one or more of real-time data, market data, performance data, historical data, utilization data, infrastructure data, or security data. These are merely examples of information that may be used as data, and the disclosure is not limited to these examples.

Incident data 102 may be generated automatically by monitoring tools that generate alerts and incident data to provide notification of high-risk actions, failures in IT environment, and may be generated as tickets. Incident data may include metadata, such as, for example, text fields, identifying codes, and time stamps.

The in-house data 103 may be stored in a relational database including an incident table. The incident table may be provided as one or more tables, and may include, for example, one or more of problems, tasks, risk conditions, incidents, or changes. The relational database may be stored in a cloud. The relational database may be connected through encryption to a gateway. The relational database may send and receive periodic updates to and from the cloud. The cloud may be a remote cloud service, a local service, or any combination thereof. The cloud may include a gateway connected to a processing API configured to transfer data to the collection point 120 or a secondary collection point 110. The incident table may include incident data 102.

Data pipeline system 100 may include third party data 199 generated and maintained by third party data producers. Third party data producers may produce incident data 102 from Internet of Things (IoT) devices, desktop-level devices, and sensors. Third party data producers may include but are not limited to Tryambak, Appneta, Oracle, Prognosis, ThousandEyes, Zabbix, ServiceNow, Density, Dyatrace, etc. The incident data 102 may include metadata indicating that the data belongs to a particular client or associated system.

The data pipeline system 100 may include a secondary collection point 110 to collect and pre-process incident data 102 from the data source 101. The secondary collection point 110 may be utilized prior to transferring data to a collection point 120. The secondary collection point 110 point may for example be an Apache Minifi software. In one example, the secondary collection point 110 may run on a microprocessor for a third party data producer. Each third party data producer may have an instance of the secondary collection point 110 running on a microprocessor. The secondary collection point 110 may support data formats including but limited to JSON, CSV, Avro, ORC, HTML, XML, and Parquet. The secondary collection point 110 may encrypt incident data 102 collected from the third party data producers. The secondary collection point 110 may encrypt incident data, including, but not limited to, Mutual Authentication Transport Layer Security (mTLS), HTTPS, SSH, PGP, IPsec, and SSL. The secondary collection point 110 may perform initial transformation or processing of incident data 102. The secondary collection point 110 may be configured to collect data from a variety of protocols, have data provenance generated immediately, apply transformations and encryptions on the data, and prioritize data.

The data pipeline system 100 may include a collection point 120. The collection point 120 may be a system configured to provide a secure framework for routing, transforming, and delivering data across from the data source 101 to downstream processing devices (e.g., the front gate processor 140). The collection point 120 may for example be a software such as Apache NiFi. The collection point 120 may receive raw data and the data's corresponding fields such as the source name and ingestion time. The collection point 120 may run on a Linux Virtual Machine (VM) on a remote server. The collection point 120 may include one or more nodes. For example, the collection point 120 may receive incident data 102 directly from the data source 101. In another example, the collection point 120 may receive incident data 102 from the secondary collection point 110. The secondary collection point 110 may transfer the incident data 102 to the collection point 120 using, for example, Site-to-Site protocol. The collection point 120 may include a flow algorithm. The flow algorithm may connect different processors, as described herein, to transfer and modify data from one source to another. For each third party data producer, the collection point 120 may have a separate flow algorithm. Each flow algorithm may include a processing group. The processing group may include one or more processors. The one or more processors may, for example, fetch incident data 102 from the relational database. The one or more processors may utilize the processing API of the in-house data 103 to make an API call to a relational database to fetch incident data 102 from the incident table. The one or more processors may further transfer incident data 102 to a destination system such as a front gate processor 140. The collection point 120 may encrypt data through HTTPS, Mutual Authentication Transport Layer Security (mTLS), SSH, PGP, IPsec, and/or SSL, etc. The collection point 120 may support data formats including but not limited to JSON, CSV, Avro, ORC, HTML, XML, and Parquet. The collection point 120 may be configured to write messages to clusters of a front gate processor 140 and communication with the front gate processor 140.

The data pipeline system 100 may include a distributed event streaming platform such as a front gate processor 140. The front gate processor 140 may be connected to and configured to receive data from the collection point 120. The front gate processor 140 may be implemented in an Apache Kafka cluster software system. The front gate processor 140 may include one or more message brokers and corresponding nodes. The message broker may for example be an intermediary computer program module that translates a message from the formal messaging protocol of the sender to the formal messaging protocol of the receiver. The message broker may be on a single node in the front gate processor 140. A message broker of the front gate processor 140 may run on a virtual machine (VM) on a remote server. The collection point 120 may send the incident data 102 to one or more of the message brokers of the front gate processor 140. Each message broker may include a topic to store similar categories of incident data 102. A topic may be an ordered log of events. Each topic may include one or more sub-topics. For example, one sub-topic may store incident data 102 relating to network problems and another topic may store incident data 102 related to security breaches from third party data producers. Each topic may further include one or more partitions. The partitions may be a systematic way of breaking the one topic log file into many logs, each of which can be hosted on a separate server. Each partition may be configured to store as much as a byte of incident data 102. Each topic may be partitioned evenly between one or more message brokers to achieve load balancing and scalability. The front gate processor 140 may be configured to categorize the received data into a plurality of client categories, thereby forming a plurality of datasets associated with the respective client categories. These datasets may be stored separately within the storage device as described in greater detail below. The front gate processor 140 may further transfer data to storage and to processors for further processing.

For example, the front gate processor 140 may be configured to assign particular data to a corresponding topic. Alert sources may be assigned to an alert topic, and incident data may be assigned to an incident topic. Change data may be assigned to a change topic. Problem data may be assigned to a problem topic.

The data pipeline system 100 may include a software framework for data storage 150. The data storage 150 may be configured for long term storage and distributed processing. The data storage 150 may be implemented using, for example, Apache Hadoop. The data storage 150 may store incident data 102 transferred from the front gate processor 140. In particular, data storage 150 may be utilized for distributed processing of incident data 102, and Hadoop distributed file system (HDFS) within the data storage may be used for organizing communications and storage of incident data 102. For example, the HDFS may replicate any node from the front gate processor 140. This replication may protect against hardware or software failures of the front gate processor 140. The processing may be performed in parallel on multiple servers simultaneously.

The data storage 150 may include an HDFS that is configured to receive the metadata (e.g., incident data). The data storage 150 may further process the data utilizing a MapReduce algorithm. The MapReduce algorithm may allow for parallel processing of large data sets. The data storage 150 may further aggregate and store the data utilizing Yet Another Resource Negotiation (YARN). YARN may be used for cluster resource management and planning tasks of the stored data. For example, a cluster computing framework, such as the processing platform 160, may be arranged to further utilize the HDFS of the data storage 150. For example, if the data source 101 stops providing data, the processing platform 160 may be configured to retrieve data from the data storage 150 either directly or through the front gate processor 140. The data storage 150 may allow for the distributed processing of large data sets across clusters of computers using programming models. The data storage 150 may include a master node and an HDFS for distributing processing across a plurality of data nodes. The master node may store metadata such as the number of blocks and their locations. The main node may maintain the file system namespace and regulate client access to said files. The main node may comprise files and directories and perform file system executions such as naming, closing, and opening files. The data storage 150 may scale up from a single server to thousands of machines, each offering local computation and storage. The data storage 150 may be configured to store the incident data in an unstructured, semi-structured, or structured form. In one example, the plurality of datasets associated with the respective client categories may be stored separately. The master node may store the metadata such as the separate dataset locations.

The data pipeline system 100 may include a real-time processing framework, e.g., a processing platform 160. In one example, the processing platform 160 may be a distributed dataflow engine that does not have its own storage layer. For example, this may be the software platform Apache Flink. In another example, the software platform Apache Spark may be utilized. The processing platform 160 may support stream processing and batch processing. Stream processing may be a type of data processing that performs continuous, real-time analysis of received data. Batch processing may involve receiving discrete data sets processed in batches. The processing platform 160 may include one or more nodes. The processing platform 160 may aggregate incident data 102 (e.g., incident data 102 that has been processed by the front gate processor 140) received from the front gate processor 140. The processing platform 160 may include one or more operators to transform and process the received data. For example, a single operator may filter the incident data 102 and then connect to another operator to perform further data transformation. The processing platform 160 may process incident data 102 in parallel. A single operator may be on a single node within the processing platform 160. The processing platform 160 may be configured to filter and only send particular processed data to a particular data sink layer. For example, depending on the data source of the incident data 102 (e.g., whether the data is in-house data 103 or third party data 199), the data may be transferred to a separate data sink layer (e.g., data sink layer 170, or data sink layer 171). Further, additional data that is not required at downstream modules (e.g., at the artificial intelligence module 180) may be filtered and excluded prior to transferring the data to a data sink layer.

The processing platform 160 may perform three functions. First, the processing platform 160 may perform data validation. The data's value, structure, and/or format may be matched with the schema of the destination (e.g., the data sink layer 170). Second, the processing platform 160 may perform a data transformation. For example, a source field, target field, function, and parameter from the data may be extracted. Based upon the extracted function of the data, a particular transformation may be applied. The transformation may reformat the data for a particular use downstream. A user may be able to select a particular format for downstream use. Third, the processing platform 160 may perform data routing. For example, the processing platform 160 may select the shortest and/or most reliable path to send data to a respective sink layer (e.g., sink layer 170 and/or sink layer 171).

In one example, the processing platform 160 may be configured to transfer particular sets of data to a data sink layer. For example, the processing platform 160 may receive input variables for a particular artificial intelligence module 180. The processing platform 160 may then filter the data received from the front gate processor 140 and only transfer data related to the input variables of the artificial intelligence module 180 to a data sink layer.

The data pipeline system 100 may include one or more data sink layers (e.g., data sink layer 170 and data sink layer 171). Incident data 102 processed from processing platform 160 may be transmitted to and stored in data sink layer 170. In one example, the data sink layer 171 may be stored externally on a particular client's server. The data sink layer 170 and data sink layer 171 may be implemented using a software such as, but not limited to, PostgreSQL, HIVE, Kafka, OpenSearch, and Neo4j. The data sink layer 170 may receive in-house data 103, which have been processed and received from the processing platform 160. The data sink layer 171 may receive third party data 199, which have been processed and received from the processing platform 160. The data sink layers may be configured to transfer incident data 102 to an artificial intelligence module 180. The data sink layers may be data lakes, data warehouses, or cloud storage systems. Each data sink layer may be configured to store incident data 102 in both a structured or unstructured format. Data sink layer 170 may store incident data 102 with several different formats. For example, data sink layer 170 may support data formats such as JavaScript Objection Notation (JSON), comma-separated value (CSV), Avro, Optimized Row Columnar (ORC), Hypertext Markup Language (HTML), Extensible Markup Language (XML), or Parquet, etc. The data sink layer (e.g., data sink layer 170 or data sink layer 171), may be accessed by one or more separate components. For example, the data sink layer may be accessed by a Non-structured Query language (“NoSQL”) database management system (e.g., a Cassandra cluster), a graph database management system (e.g., Neo4j cluster), further processing programs (e.g., Kafka+Flink programs), and a relation database management system (e.g., postgres cluster). Further processing may thus be performed prior to the processed data being received by an artificial intelligence module 180.

The data pipeline system 100 may include an artificial intelligence module 180. The artificial intelligence module 180 may include a machine-learning component. The artificial intelligence module 180 may use the received data in order to train and/or use a machine learning model. The machine learning model may be, for example, a neural network. Nonetheless, it should be noted that other machine learning techniques and frameworks may be used by the artificial intelligence module 180 to perform the methods contemplated by the present disclosure. For example, the systems and methods may be realized using other types of supervised and unsupervised machine learning techniques such as regression problems, random forest, cluster algorithms, principal component analysis (PCA), reinforcement learning, or a combination thereof. The artificial intelligence module 180 may be configured to extract and receive data from the data sink layer 170.

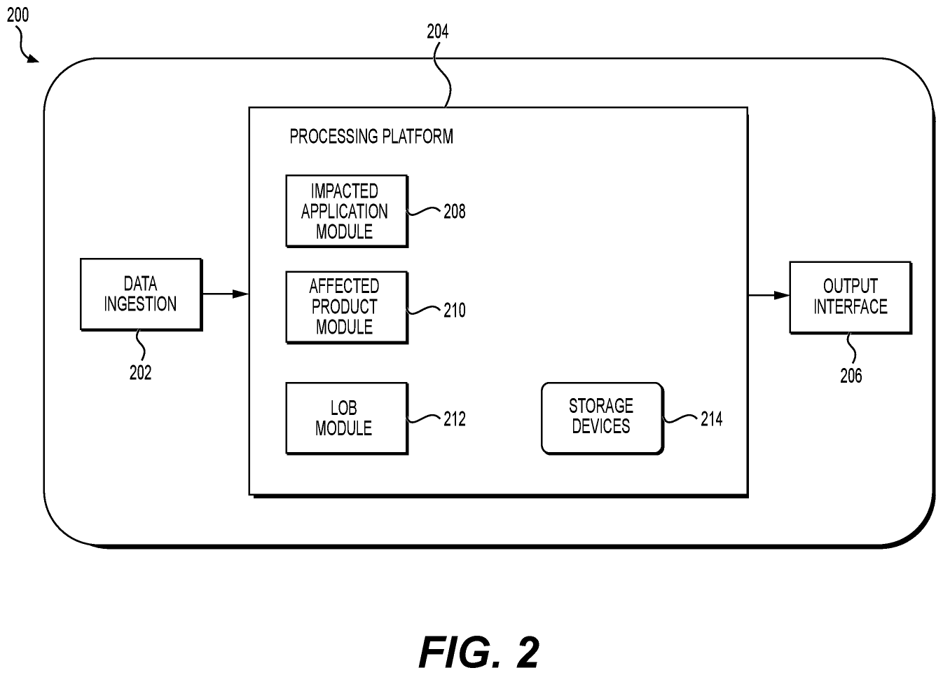

FIG. 2 depicts an exemplary block diagram of a system 200 for determining a list of related configurable items to an incident, according to one or more embodiments. The system 200 may be implemented by aspects of the data pipeline system 100 of FIG. 1 or by any computer process system such as device 600

The system 200 may include a data ingestion tool 202, a processing platform 204, and an output interface 206.

The data ingestion tool 202 may refer to a process and system for facilitating a transfer of the incident and incident data to the various tools, modules, components, and devices that are used for determining a list of related configurable items to an incident, according to one or more embodiments.

The data ingestion tool 202 may be configured to receive metadata of configurable items and incidents. For example, the data ingestion tool 202 may include an application programming integrate (API) configured to receive configurable item metadata and incident data (e.g., metadata related to each incident). The incident data may include incident reports with information for each incident provided with one or more of an incident number, closed date/time, category, close code, close note, long description, short description, root cause, or assignment group. Incident data may include incident reports with information for each incident provided with one or more of an issue key, description, summary, label, issue type, fix version, environment, author, or comments. Incident data may include incident reports with information for each incident provided with one or more of a file name, script name, script type, script description, display identifier, message, committer type, committer link, properties, file changes, or branch information. Incident data may include one or more of real-time data, market data, performance data, historical data, utilization data, infrastructure data, or security data.

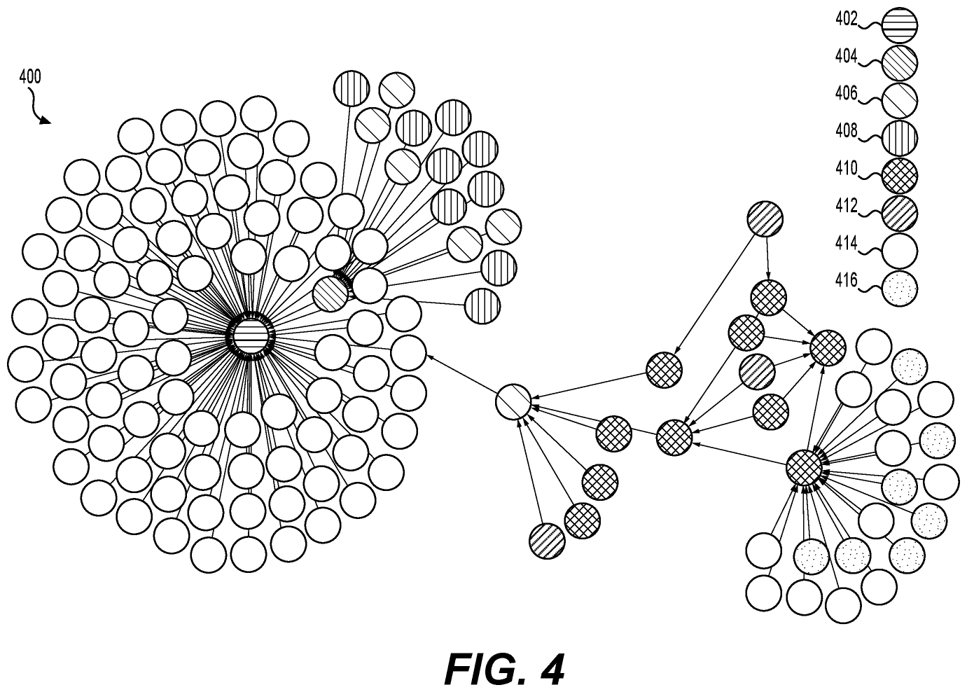

The data ingestion tool 202 may further receive metadata including a CMDB_CI and all corresponding data within a CMDB_CI. For example, this may include a particular CI's attributes, dependencies, and change to its configuration over time. This may include a line of business of a particular CI. The line of business may include association logic linking a line of business with one or more of: business services, service offerings, applications, application instances or web services, and/or servers and services (as depicted in FIG. 4).

The data ingestion tool 202 may further receive metadata including historical incident data. The historical incident data may include data that is input by a user. The historical incident data may include metadata of past incidents related to a configurable item. This historical incident data may further include user inputted information related to the previous incident. For example, the historical incident data may include any related applications and services, as well as related products, that may have been affected for a particular configurable item's incident. This information may be stored on separate servers or as part of the CMDB_CIs. These are merely examples of information that may be received as data by the data ingestion tool 202, and the disclosure is not limited to these examples.

The incident data received at data ingestion tool 202 may be for example retrieved from the data sink layer 170 of FIG. 1. The data received by the data ingestion tool 202 may have previously been processed and filtered to only provide incident data. The data may further have been filtered to provide incident of a particular external systems. In another example, the incident data may be received by an electronic network, such as the Internet, through one or more computers, servers, and/or handheld mobile devices. The electronic network may be connected so as to provide incident data generated automatically by an external system by monitoring tools that generate alerts and incident data to provide notification of high-risk actions, failures in IT environment, and may be generated as tickets. The data ingestion tool 202 may be configured to transfer the received data to the processing platform 204.

In one embodiment, the processing platform 204 may be a platform with multiple interconnected components. The processing platform 204 may include one or more servers, intelligent networking devices, computing devices, components, and corresponding software for determining a list of configurable items for incident correlation. In addition, it is noted that the processing platform 204 may be a separate entity of system 200. Further details of the processing platform 204 may be provided below.

The processing platform 204 may include an impacted application module 208, an affected product module 210, a line of business (LOB) module 212, and one or more storage devices 214.

The impacted application module 208 may for example be configured to determine a list of related configurable items based on related applications and services. The determined list may include related configurable items based on two forms of connections: (1) correlated applications and services stored in a database, and (2) empirically linked applications and services. For example, the impacted application module 208 may receive as input data from data ingestion tool 202 or from the one or more storage devices 214.

The impacted application module 208 may receive the configurable items related to corresponding applications and services based on database correlations. Correlated configurable item lists may be extracted from this database (e.g., the CMDB_CI) by the impacted application module 208.

The impacted application module 208 may further receive empirical data for one or more configurable items. For example, the data may include empirical data of all previous incidents and externally inputted associations between related applications and services with respect to an incident. For example, if a particular application or service is associated with configurable item A, all past incident and incident data related to the application or service associated with configurable item A may be received. This may include empirical data that lists any associated application or service, and a corresponding configurable item, that were impacted by the same incidents. This may mean that all past incidents of the application and service associated with configurable item A may be linked to other impacted applications and services that experienced issues during the incident.

The impacted application module 208 may include an association model. The association model may include machine learning and data mining algorithms to identify correlations between related configurable items. The association model may for example be trained to analyze the empirical data that has linked configurable items based on past incidents. The association model may thus be trained to receive as input a particular configurable item and to analyze the frequency of correlations between the particular configurable item and all other configurable items. In particular, the association model may review related applications and services impacted from a past incident to determine the configurable items. All configurable items may be assigned an association score that measures how frequently two configurable items were related in past incidents (based on the empirical data). The association model may further include a threshold value to determine related configurable items. For example, the association score may be between 0 to 1. For example, the threshold value may be an assigned score of 0.8. The association model may output a list of any configurable items with an association score greater than the threshold value.

The association model of the impacted application module 208 may for example utilize algorithms such as Apriori, Eclat, and Frequent Pattern (FP)-growth. Further, the association model may generate rules from associated items. The association model may be trained with pre-processed data including configurable item associations.

The impacted application module 208 may be configured to output a list of related configurable items. The list may for example include all configurable items associated based on their corresponding applications and services in a server. The list may further include all configurable items outputted by the association model as having an association score greater than the threshold value. The list may be saved to one or more digital storage device 214.

The affected product module 210 may for example be configured to determine a list of related configurable items based on related products. The determined list may include related configurable items based on two forms of connections: (1) correlated products stored in a database, and (2) empirically linked products. For example, the affected product module 210 may receive as input data from data ingestion tool 202 or from the one or more storage devices 214.

The affected product module 210 may receive the configurable items related to corresponding products based on database correlations. Correlated configurable item lists may be extracted from this database (e.g., the CMDB_CI) by the affected product module 210.

The affected product module 210 may further receive empirical data for one or more configurable items. For example, the data may include empirical data of all previous incidents and externally inputted associations between related products with respect to an incident. For example, if a particular product is associated with configurable item B, all past incident and incident data related to the products associated with configurable item B may be received. This may include empirical data that lists any associated products, and corresponding configurable items, that were impacted by the same incidents. This may mean that all past incidents of the products associated with configurable item B may be linked to other impacted products that experienced issues during the incident.

The affected product module 210 may include an association model. The association model may include machine learning and data mining algorithms to identify correlations between related configurable items. The association model may for example be trained to analyze the empirical data that has linked configurable items based on past incidents. The association model may thus be trained to receive as input a particular configurable item and to analyze the frequency of correlations between the particular configurable item and all other configurable items. In particular, the association model may review related products impacted from a past incident to determine the configurable items. All configurable items may be assigned an association score that measures how frequently two configurable items were related in past incidents (based on the empirical data). The association model may further include a threshold value to determine related configurable items. For example, the association score may be between 0 to 1. For example, the threshold value may be an assigned score of 0.8. The association model may output a list of any configurable items with an association score greater than the threshold value.

The association model of the affected product module 210 may for example utilize algorithms such as Apriori, Eclat, and Frequent Pattern (FP)-growth. Further, the association model may generate rules from associated items. The association model may be trained with pre-processed data including configurable item associations.

The affected product module 210 may be configured to output a list of related configurable items. The list may for example include all configurable items associated based on their corresponding products in a server. The list may further include all configurable items outputted by the association model as having an association score greater than the threshold value. The list may be saved to one or more digital storage device 214.

The LOB module 212 may for example be configured to determine a list of related configurable items based on the configurable items' lines of business. For example, the LOB module 212 may receive as input data from data ingestion tool 202 or from the one or more storage devices 214.

The LOB module 212 may for example receive a line of business for a particular configurable item. In one example, a line of business may be extracted from the metadata related to the incident/configurable item. It may for example be listed in the description of the configurable item or the incident. An exemplary line of business may include association logic linking, a line of business with one or more of: business services, service offerings, applications, application instances or web services, and/or servers and services. Each line of business may for example have hundreds or even thousands of associated configurable items. The LOB module 212 may for example be trained to review the associated configurable items and to determine a list of most relevant configurable items.

FIG. 4 depicts an exemplary chart 400 of the line of business 402 associated with an exemplary configurable item, according to one or more embodiments. A line of business 402 may include various association with other related items. For example, a line of business 402 may be associated with one or more business services 402, business services 404, service offerings 406, service offerings for a particular customer 408, applications 410, web services 412, servers 414, and/or services 416. Each business service 404 may for example be made up of one or more service offering 406 and/or service offerings for a particular customer 408. Each service offering 406 and service offering for a particular customer 408 may be broken into applications 410. An application 410 may for example generate an application instance or web service 412. Each web service 412 may further be made up of server and services 416. Each of the one or more business services 404 service offerings 406, service offerings for a particular customer 408, applications 410, web services 412, servers 414, and/or services 416 may include a corresponding configurable item.

The LOB module 212 of FIG. 2 may include algorithms that may analyze and sort the logical connections of a determined line of business and extract all applications 410, business services 404, service offerings 406, service offerings for a particular customer 408, and/or web services 412 and their corresponding configurable items (collectively referred to as the application and services).

The LOB module 212 may analyze the connected applications and services corresponding to the particular line of business associated with a particular configurable item. This may lead to an initial list of configurable items all corresponding to applications and/or services with the same line of business.

Next, the LOB module 212 may for example include an association module. The association module of LOB module 212 may for example be trained the same as and include the same capabilities as the association module of the application module 208. The association module of the LOB module 212 may then receive and review the empirical data about historic incidents. The association module may then analyze all applications and services of the initial list determined by the LOB module 212 to assign an association score. The LOB module 212 may then, based on the association score of each application or service being above a threshold value, assign the configurable item of each application or service to a determined list. The list may be saved to one or more digital storage device 214.

The output interface 206 may be configured to aggregate the lists from the impacted application module 208, the affected product module 210, and the LOB module 212, and output an aggregated list to another component, a user interface, a server, or a downstream process. The list may be exported to a user or another device. The output interface 206 may be configured to apply a filter algorithm that may remove repeated configurable items between the lists.

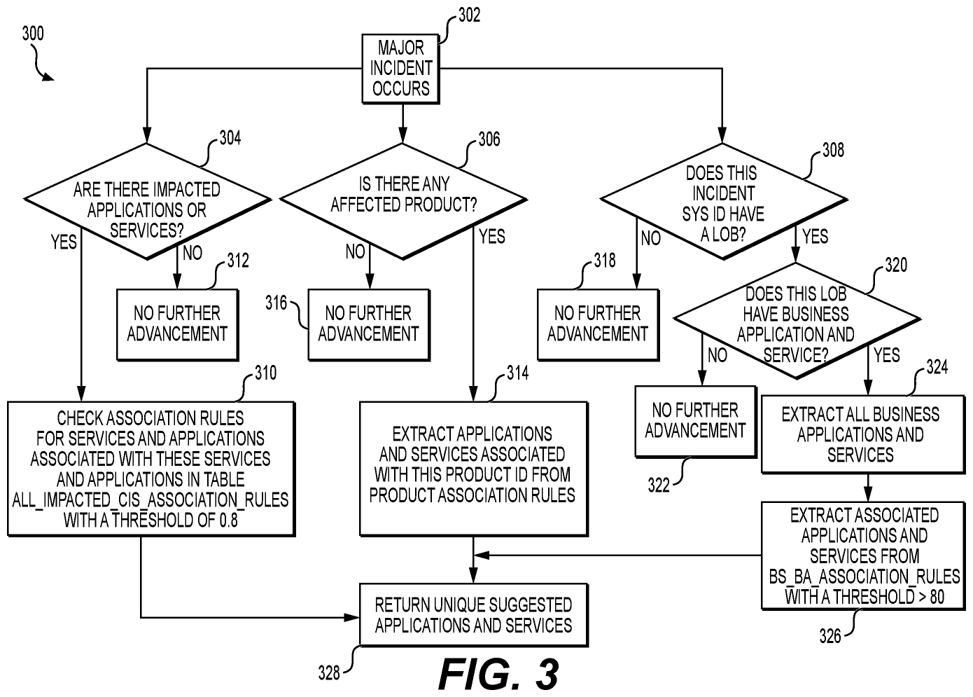

FIG. 3 depicts an exemplary flowchart 300 for determining a list of related configurable items to an incident, according to one or more embodiments. The flowchart 300 may for example be performed by the system 200.

First, at step 302, an incident may occur and may be reported via a particular data object, where the data object is representative of a configurable item. An information technology (IT) management system (e.g., system 200) may receive information on an incident corresponding to a particular configurable item. The system 200 may further receive a corresponding CBDB_CI and empirical data related to the particular configurable item and the incident. The system may for example receive incident data through data ingestion tool 202.

At step 304, the system (e.g., system 200) may determine whether there are impacted applications and/or services. This may include determining a list of configurable items corresponding to related applications or services that may also be affected by the incident at step 302. A first module (e.g., the application module 208) may determine any database correlations of related applications and services (and their corresponding configurable items) to the particular configurable item that corresponds to the incident at step 302. This may be done by accessing a database (e.g., the CMDB_CI database) and extracting associated and/or linked applications and services, as well as the corresponding configurable items. These related configurable items may be saved to storage (e.g., one or more storage devices 214) and output (e.g., via an output interface 206).

The first module may further input the empirical data into an association model and determine a list of empirically related applications and services to the particular configurable item from step 302. This may be done by determining an association score for applications and services of a database (e.g., by using the association model of the impacted application module 208). Applications and services that were previously linked to the particular configurable item in past incidents may have a higher association score. The first model may determine a list of configurable items that have received an association score.

At step 312, if there are no associated configurable items from the database or no configurable items assigned with an association score greater than zero, then no further action may be taken from the first model.

At step 310, the first model may review the outputted association scores for applications and services (and their corresponding configurable items). The first model may determine whether a related application or service has an association score greater than a threshold value, and save the configurable item to a list for storage and output if the association score is greater than the threshold value. In one embodiment, the threshold value may be 0.8.

The list of related configurable items from the database and association model with an association score greater than the threshold value may be saved and used later at step 328.

At step 306, the system (e.g., system 200) may determine whether there are impacted products. This may include determining a list of configurable items corresponding to related products that may also be affected by the incident at step 302. A second module (e.g., the affected product module 210) may determine any database correlations of related products (and their corresponding configurable item) to the particular configurable item that corresponds to the incident at step 302. This may be done by accessing a database (e.g., the CMDB_CI database) and extracting associated and/or linked products, as well as the corresponding configurable item. These related product configurable items may be saved to storage (e.g., one or more storage devices 214) and output (e.g., via an output interface 206).

The second module may further input the empirical data into an association model and determine a list of empirically related products to the particular configurable item from step 302. This may be done by determining an association score for products of a database (e.g., by using the association model of the affected product module 210). Products that were previously linked to the particular configurable item in past incidents may have a higher association score. The second model may determine a list of configurable items that have received an association score.

At step 316, if there are no associated configurable items from the database or no configurable items assigned with an association score greater than zero, then no further action may be taken from the first model.

At step 314, the second model may review the outputted association scores for products (and their corresponding configurable item). The second model may determine whether the related products has an association score greater than a threshold value, and save the configurable item to a list for storage and output if the association score is greater than the threshold value. In one embodiment, the threshold value may be a score of 0.8.

The list of related configurable items from the database and association model with an association score greater than the threshold value may be saved and used later at step 328

At step 308, the a third module (e.g., the LOB module 212) may for example run an algorithm to search through the configurable item's description and determine a related line of business. If the algorithm does not find a line of business association, then at step 318, no further action may be performed by the third module.

At step 320, if a line of business is determined, the third module may apply an algorithm to extract logically related applications and services from the particular line of business. At step 322, if no logically related applications or services exist, then no further action may be performed by the third module.

At step 324, the third module may extract related applications and services and their corresponding configurable items. Next an association model (e.g., the association model of the LOB module 212) may be applied to determine an association score for each of the extracted application or services.

At step 326, the third model may for example determine a list of related configurable items, wherein the list includes applications and services related to the line of business and assigned an association score greater than a threshold value. These configurable items may then be saved and output for further use.

At step 328, the system (e.g., system 200) may compile the list of configurable items from the first module, second module, and third module to determine a list of relevant configurable items to output. This list may be a list of configurable items that may be related or also impacted by the incident from step 302. At step 328, a filter may further be applied to remove repeats from the list of configurable items. Additionally or alternatively, if a configurable item is listed by more than one of the modules, this may be indicated (e.g., whether twice or three times) and may be output with the list.

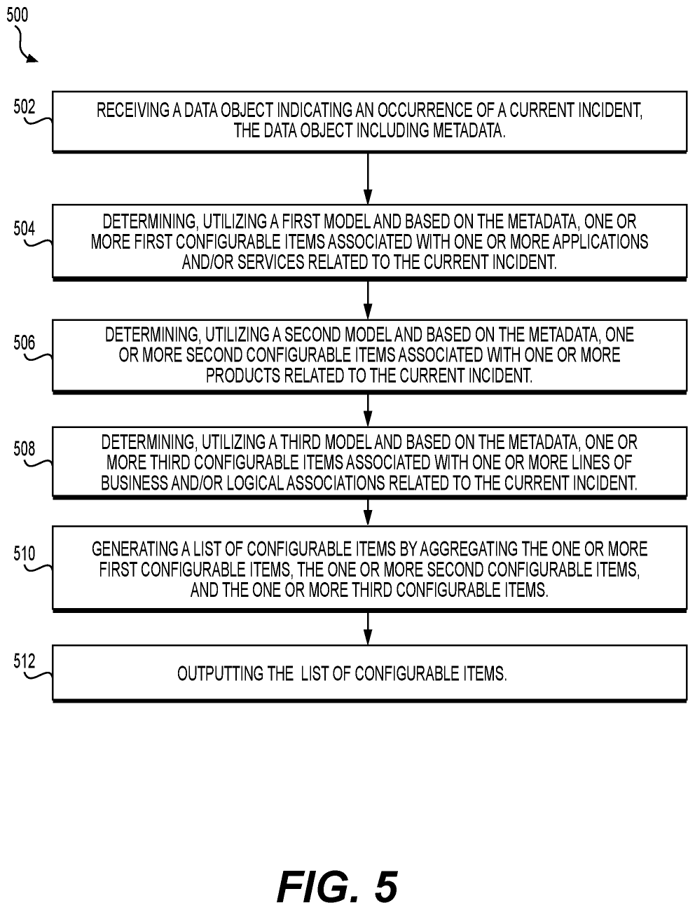

FIG. 5 depicts a flowchart for determining a list of related configurable items to an incident, according to one or more embodiments.

At step 502, a data object indicating an occurrence of a current incident may be received, the data object including metadata. The data object may be representative of a configurable item. The metadata may include historical incident data for the data object and a line of business for the data object. The line of business for the data object may include an association logic linking the line of business with one or more of a business service, a service offering, an application, an application instance or web service, a server, or a service.

At step 504, one or more first configurable items associated with one or more applications and/or services related to the current incident may be determined utilizing a first model and based on the metadata. This may include analyzing historical incident data utilizing an association model to determine configurable items that were affected during one or more past incidents related to the one or more applications and/or services.

At step 506, one or more second configurable items associated with one or more products related to the current incident may be determined utilizing a second model and based on the metadata. This may include analyzing historical incident data utilizing an association model to determine configurable items that were affected during one or more past incidents related to the one or more products.

At step 508, one or more third configurable items associated with one or more lines of business and/or logical associations related to the current incident may be determined utilizing a third model and based on the metadata. This may include confirming that the one or more lines of business are stored in association with the current incident. This may further include searching logical levels for the one or more lines of business to determine one or more businesses and/or applications related to the one or more lines of business. This may then include extracting one or more configurable items associated with the one or more businesses and/or applications. This may then include applying an association model to the extracted one or more configurable items associated with the one or more businesses and/or applications to determine the one or more third configurable items, wherein the association model is configured to determine configurable items that have been affected by past incidents that also affected the current incident.

At step 510, a list of configurable items may be generated by aggregating the one or more first configurable items, the one or more second configurable items, and the one or more third configurable items. The list of configurable items may be filtered to remove any redundant configurable items.

At step 512, the list of configurable items may be output. The list may be output to a user via a user interface of a computing device. In other embodiment, the list may be output to other components within the system or to downstream components for further processing.

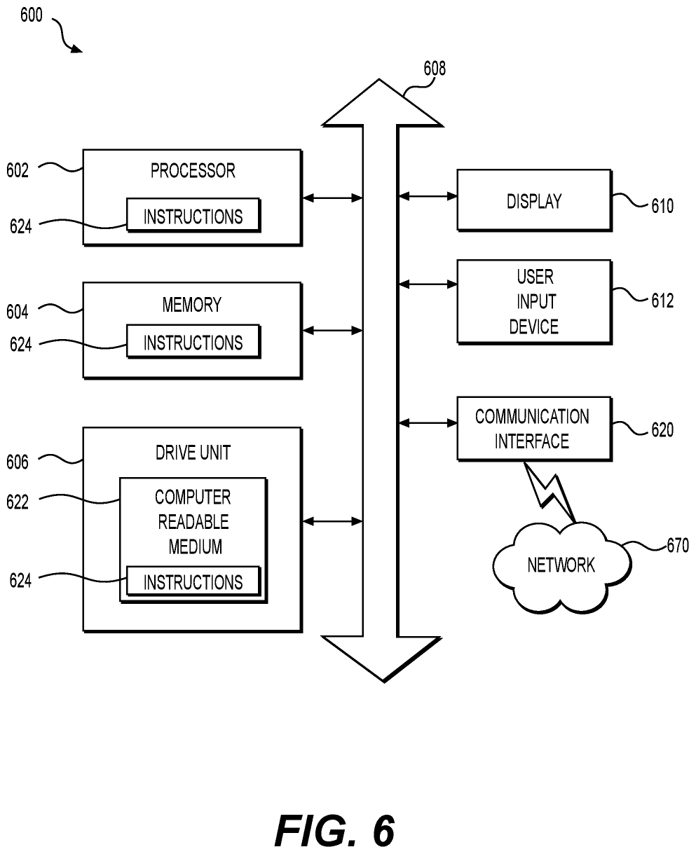

FIG. 6 illustrates a computer system for executing the techniques described herein, according to one or more embodiments of the present disclosure. As illustrated in FIG. 6, the computer system 600 may include a processor 602, e.g., a central processing unit (CPU), a graphics processing unit (GPU), or both. The processor 602 may be a component in a variety of systems. For example, the processor 602 may be part of a standard personal computer or a workstation. The processor 602 may be one or more general processors, digital signal processors, application specific integrated circuits, field programmable gate arrays, servers, networks, digital circuits, analog circuits, combinations thereof, or other now known or later developed devices for analyzing and processing data. The processor 602 may implement a software program, such as code generated manually (i.e., programmed).

The computer system 600 may include a memory 604 that can communicate via a bus 608. The memory 604 may be a main memory, a static memory, or a dynamic memory. The memory 604 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one implementation, the memory 604 includes a cache or random-access memory for the processor 602. In alternative implementations, the memory 604 is separate from the processor 602, such as a cache memory of a processor, the system memory, or other memory. The memory 604 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 604 is operable to store instructions executable by the processor 602. The functions, acts or tasks illustrated in the figures or described herein may be performed by the programmed processor 602 executing the instructions stored in the memory 604. The functions, acts or tasks are independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel payment and the like.

As shown, the computer system 600 may further include a display unit 610, such as a liquid crystal display (LCD), an organic light emitting diode (OLED), a flat panel display, a solid-state display, a cathode ray tube (CRT), a projector, a printer or other now known or later developed display device for outputting determined information. The display 610 may act as an interface for the user to see the functioning of the processor 602, or specifically as an interface with the software stored in the memory 604 or in the drive unit 606.

Additionally or alternatively, the computer system 600 may include an input device 612 configured to allow a user to interact with any of the components of system 600. The input device 612 may be a number pad, a keyboard, or a cursor control device, such as a mouse, or a joystick, touch screen display, remote control, or any other device operative to interact with the computer system 600.

The computer system 600 may also or alternatively include a disk or optical drive unit 606. The disk drive unit 606 may include a computer-readable medium 622 in which one or more sets of instructions 624, e.g., software, can be embedded. Further, the instructions 624 may embody one or more of the methods or logic as described herein. The instructions 624 may reside completely or partially within the memory 604 and/or within the processor 602 during execution by the computer system 600. The memory 604 and the processor 602 also may include computer-readable media as discussed above.

In some systems, a computer-readable medium 622 includes instructions 624 or receives and executes instructions 624 responsive to a propagated signal so that a device connected to a network 670 can communicate voice, video, audio, images, or any other data over the network 670. Further, the instructions 624 may be transmitted or received over the network 670 via a communication port or interface 620, and/or using a bus 608. The communication port or interface 620 may be a part of the processor 602 or may be a separate component. The communication port 620 may be created in software or may be a physical connection in hardware. The communication port 620 may be configured to connect with a network 670, external media, the display 610, or any other components in system 600, or combinations thereof. The connection with the network 670 may be a physical connection, such as a wired Ethernet connection or may be established wirelessly as discussed below. Likewise, the additional connections with other components of the system 600 may be physical connections or may be established wirelessly. The network 670 may alternatively be directly connected to the bus 608.

While the computer-readable medium 622 is shown to be a single medium, the term “computer-readable medium” may include a single medium or multiple media, such as a centralized or distributed database, and/or associated caches and servers that store one or more sets of instructions. The term “computer-readable medium” may also include any medium that is capable of storing, encoding, or carrying a set of instructions for execution by a processor or that cause a computer system to perform any one or more of the methods or operations disclosed herein. The computer-readable medium 622 may be non-transitory, and may be tangible.

The computer-readable medium 622 can include a solid-state memory such as a memory card or other package that houses one or more non-volatile read-only memories. The computer-readable medium 622 can be a random-access memory or other volatile re-writable memory. Additionally or alternatively, the computer-readable medium 622 can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative implementation, dedicated hardware implementations, such as application specific integrated circuits, programmable logic arrays and other hardware devices, can be constructed to implement one or more of the methods described herein. Applications that may include the apparatus and systems of various implementations can broadly include a variety of electronic and computer systems. One or more implementations described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

The computer system 600 may be connected to one or more networks 670. The network 670 may define one or more networks including wired or wireless networks. The wireless network may be a cellular telephone network, an 802.11, 802.16, 802.20, or WiMAX network. Further, such networks may include a public network, such as the Internet, a private network, such as an intranet, or combinations thereof, and may utilize a variety of networking protocols now available or later developed including, but not limited to TCP/IP based networking protocols. The network 670 may include wide area networks (WAN), such as the Internet, local area networks (LAN), campus area networks, metropolitan area networks, a direct connection such as through a Universal Serial Bus (USB) port, or any other networks that may allow for data communication. The network 670 may be configured to couple one computing device to another computing device to enable communication of data between the devices. The network 670 may generally be enabled to employ any form of machine-readable media for communicating information from one device to another. The network 670 may include communication methods by which information may travel between computing devices. The network 670 may be divided into sub-networks. The sub-networks may allow access to all of the other components connected thereto or the sub-networks may restrict access between the components. The network 670 may be regarded as a public or private network connection and may include, for example, a virtual private network or an encryption or other security mechanism employed over the public Internet, or the like.

In accordance with various implementations of the present disclosure, the methods described herein may be implemented by software programs executable by a computer system. Further, in an exemplary, non-limited implementation, implementations can include distributed processing, component/object distributed processing, and parallel payment. Alternatively, virtual computer system processing can be constructed to implement one or more of the methods or functionality as described herein.

Although the present specification describes components and functions that may be implemented in particular implementations with reference to particular standards and protocols, the disclosure is not limited to such standards and protocols. For example, standards for Internet and other packet switched network transmission (e.g., TCP/IP, UDP/IP, HTML, HTTP, etc.) represent examples of the state of the art. Such standards are periodically superseded by faster or more efficient equivalents having essentially the same functions. Accordingly, replacement standards and protocols having the same or similar functions as those disclosed herein are considered equivalents thereof.

It will be understood that the steps of methods discussed are performed in one embodiment by an appropriate processor (or processors) of a processing (i.e., computer) system executing instructions (computer-readable code) stored in storage. It will also be understood that the disclosed embodiments are not limited to any particular implementation or programming technique and that the disclosed embodiments may be implemented using any appropriate techniques for implementing the functionality described herein. The disclosed embodiments are not limited to any particular programming language or operating system.

It should be appreciated that in the above description of exemplary embodiments, various features of the embodiments are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that a claimed embodiment requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment.

Furthermore, while some embodiments described herein include some but not other features included in other embodiments, combinations of features of different embodiments are meant to be within the scope of the present disclosure, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the function.

In the description provided herein, numerous specific details are set forth. However, it is understood that embodiments of the present disclosure may be practiced without these specific details. In other instances, well-known methods, structures and techniques have not been shown in detail in order not to obscure an understanding of this description.

Similarly, it is to be noticed that the term coupled, when used in the claims, should not be interpreted as being limited to direct connections only. The terms “coupled” and “connected,” along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical or electrical contact, or that two or more elements are not in direct contact with each other but yet still co-operate or interact with each other.

Thus, while there has been described what are believed to be the preferred embodiments of the present disclosure, those skilled in the art will recognize that other and further modifications may be made thereto without departing from the spirit of the present disclosure, and it is intended to claim all such changes and modifications as falling within the scope of the present disclosure. For example, any formulas given above are merely representative of procedures that may be used. Functionality may be added or deleted from the block diagrams and operations may be interchanged among functional blocks. Steps may be added or deleted to methods described within the scope of the present disclosure.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations and implementations are possible within the scope of the disclosure. Accordingly, the disclosure is not to be restricted except in light of the attached claims and their equivalents.

What is claimed is:

1. A computer implemented method for determining a list of configurable items related to an incident, the method comprising:
receiving a data object indicating an occurrence of a current incident, the data object including metadata;
determining, utilizing a first model and based on the metadata, one or more first configurable items associated with one or more applications and/or services related to the current incident;
determining, utilizing a second model and based on the metadata, one or more second configurable items associated with one or more products related to the current incident;
determining, utilizing a third model and based on the metadata, one or more third configurable items associated with one or more lines of business and/or logical associations related to the current incident;
generating a list of configurable items by aggregating the one or more first configurable items, the one or more second configurable items, and the one or more third configurable items; and
outputting the list of configurable items.

2. The method of claim 1, further including:
filtering the list of configurable items to remove any redundant configurable item.

3. The method of claim 1, wherein determining the one or more third configurable items includes confirming that the one or more lines of business are stored in association with the current incident.

4. The method of claim 3, wherein determining the one or more third configurable items further includes:
searching logical levels for the one or more lines of business to determine one or more businesses and/or applications related to the one or more lines of business.

5. The method of claim 4, wherein determining the one or more third configurable items further includes:
extracting one or more configurable items associated with the one or more businesses and/or applications.

6. The method of claim 5, wherein determining the one or more third configurable items further includes:
applying an association model to the extracted one or more configurable items associated with the one or more businesses and/or applications to determine the one or more third configurable items, wherein the association model is configured to determine configurable items that have been affected by past incidents that also affected the current incident.

7. The method of claim 1, wherein determining the one or more first configurable items includes analyzing historical incident data utilizing an association model to determine configurable items that were affected during one or more past incidents related to the one or more applications and/or services.

8. The method of claim 7, wherein the historical incident data includes data that is input by a user to indicate applications and/or services related to past incidents.

9. The method of claim 1, wherein determining the one or more second configurable items includes analyzing historical incident data utilizing an association model to determine configurable items that were affected during one or more past incidents related to the one or more products.

10. The method of claim 9, wherein the historical incident data includes data that is input by a user to indicate products related to past incidents.

11. The method of claim 1, wherein the data object is representative of a configurable item.

12. The method of claim 1, wherein the metadata includes:
historical incident data for the data object; and
a line of business for the data object, the line of business including an association logic linking the line of business with one or more of:
a business service, a service offering, an application, an application instance or web service, a server, or a service.

13. A system for a data pipeline, the system comprising:
a memory having processor-readable instructions stored therein; and
at least one processor configured to access the memory and execute the processor-readable instructions to perform operations including:
receiving a data object indicating an occurrence of a current incident, the data object including metadata;
determining, utilizing a first model and based on the metadata, one or more first configurable items associated with one or more applications and/or services related to the current incident;
determining, utilizing a second model and based on the metadata, one or more second configurable items associated with one or more products related to the current incident;
determining, utilizing a third model and based on the metadata, one or more third configurable items associated with one or more lines of business and/or logical associations related to the current incident;
generating a list of configurable items by aggregating the one or more first configurable items, the one or more second configurable items, and the one or more third configurable items; and
outputting the list of configurable items.

14. The system of claim 13, the operations further including:
filtering the list of configurable items to remove any redundant configurable item.

15. The system of claim 13, wherein determining the one or more third configurable items includes confirming that the one or more lines of business are stored in association with the current incident.

16. The system of claim 15, wherein determining the one or more third configurable items further includes:
searching logical levels for the one or more lines of business to determine one or more businesses and/or applications related to the one or more lines of business.

17. The system of claim 16, wherein determining the one or more third configurable items further includes:
extracting one or more configurable items associated with the one or more businesses and/or applications.

18. The system of claim 17, wherein determining the one or more third configurable items further includes:
applying an association model to the extracted one or more configurable items associated with the one or more businesses and/or applications to determine the one or more third configurable items, wherein the association model is configured to determine configurable items that have been affected by past incidents that also affected the current incident.

19. The system of claim 13, wherein determining the one or more first configurable items includes analyzing historical incident data utilizing an association model to determine configurable items that were affected during one or more past incidents related to the one or more applications and/or services.

20. A non-transitory computer readable medium storing processor-readable instructions which, when executed by at least one processor, cause the at least one processor to perform operations including:
receiving a data object indicating an occurrence of a current incident, the data object including metadata;
determining, utilizing a first model and based on the metadata, one or more first configurable items associated with one or more applications and/or services related to the current incident;
determining, utilizing a second model and based on the metadata, one or more second configurable items associated with one or more products related to the current incident;
determining, utilizing a third model and based on the metadata, one or more third configurable items associated with one or more lines of business and/or logical associations related to the current incident;
generating a list of configurable items by aggregating the one or more first configurable items, the one or more second configurable items, and the one or more third configurable items; and
outputting the list of configurable items.
